(19) United States
(12) Patent Application Publication
(10) Pub. No.: US 2013/0221652 A1
(43) Pub. Date: Aug. 29, 2013

(54) Imprinted Tape for Combined Functional and Decorative Purposes

(71) Applicant: Martez Wilson, Metairie, LA (US)

(72) Inventor: Martez Wilson, Metairie, LA (US)

(21) Appl. No.: 13/586,175

(22) Filed: Aug. 15, 2012

Related U.S. Application Data
(60) Provisional application No. 61/603,640, filed on Feb. 27, 2012.

(51) Int. Cl. B42D 15/00

(52) U.S. Cl. CPC B42D 15/00
USPC 283/62

(57) ABSTRACT

In order to spat an athletic performer's shoes to reinforce the foot and the ankle, an elongated tape formed of a flexible base Is coated on one side with a pressure-sensitive adhesive and imprinted on the other side with repetitive versions of a team or sponsor's trademark, logo,, or the like in colors associated with the team, or sponsor. The tape may be used by wrapping the shoes and ankles in a manner known as spatting to reinforce the shoes and display the imprinted design,

### CROSS-REFERENCE TO RELATED APPLICATIONS

This application claims priority of U.S. Provisional Application 61/603,640 filed Feb. 27,2012, the contents of which are incorporated herein by reference.

### FIELD OF THE INVENTION

This invention relates to adhesive tape imprinted with company logos, team colors, and the like for use in spatting athletic shoes and related purposes.

### BACKGROUND OF THE INVENTION

Spatting is a process of taping over cleats worn by football players to provide more foot and ankle support than is provided by the generally soft sided athletic shoes. The tape is typically applied over the shoe and around the feet and ankles of a player after the player dons the cleats and usually extends around the bottom of the shoe between the football cleats. By spatting over the cleats they are able to substantially minimize the possibility of their ankles rolling which can result in a sprain.

Many professional football players are under contract to wear a particular brand of shoes during games for publicity purposes. Spatting over the shoes may obscure the company logos on the shoes and also change the shoe appearance to minimize spectator recognition of the shoe source. The brand owners therefore discourage or prohibit players under contract from wearing spatted cleats.

### SUMMARY OF THE INVENTION

The present invention is accordingly directed toward unique forms of tape which will resolve this conflict between the players' desire to spat their shoes and the brand owners' desire to obtain publicity by the use of their shoes in football games without the identifying characteristics of the shoe being hidden by spatting tape.

Broadly, the present invention is directed toward tapes which are imprinted or otherwise marked with a manufacturer's logo or related sponsor-identifying designs and colors. These logos and related designs can be imprinted on a roll of tape so that the design appears on a number of locations on the shoe after it is spatted, using the tape of the present invention. The same tape could also be used to tape the wrists of the players as well as for a variety of related purposes.

Tape formed in accordance with the present invention can assume a variety of designs. Conventionally players have used black tape for spatting purposes and accordingly black adhesive tape with the shoe brand logo appearing repeatedly on the tape would be one form of the present invention. Alternatively, the tape could be imprinted with the logo of the players' team, its sponsors, and similar promotional material.

The tape could have a background color based on the team's predominant color, usually the color of the uniforms and the like, or a color associated with the brand owner. The tape could also be tied in with other promotions such as during breast cancer awareness month, by imprinting pink tape with the shoe brand logo, the team's logo, its sponsors, and the like on the tape in a contrasting color.

The tape could be transparent with the company logo and other related information imprinted thereon so that the underlying logos on the shoe could be seen through the tape.

The tape material could range from a paper base to a fabric base or a plastic base, as long as the tape is sufficiently flexible and has sufficient tensile strength to create the spatting and the like.

The imprinting on the tape can be of any desired color as long as it provides a reasonable contrast with the background. Tapes could also be provided with logos of sponsors such as Gatorade, Pepsi, etc. or graphic material such as drawings or photos.

The tape used in connection with the present invention may have the same compositions and pressure-sensitive adhesives on one side, as well as the same dimension, as tapes presently used for spatting. They may vary from one inch to up to about three inches in width. The base materials may be paper compositions, fabric compositions, or plastic compositions. When fabric compositions are used, the logos or the like may be woven into the base fabric. Alternatively, they may be imprinted onto the tape base on the non-adhesive side.

The process of spatting shoes may involve taping prior to insertion in the athletic shoes, taping after the insertion of the foot into the athletic shoes, or combinations of both.

In either form of taping it is important to tape the ankles to minimize the possibility of ankle rollover injuries which can result in sprains putting the athletes out of action for some period of time. One preferred form of taping would be to tape the ankles with several turns around the arch of the foot, then insert the foot into a shoe and tape the outside of the shoe with the arch support extending into several turns around the ankle. However, any form of taping can be used with the present invention.

### BRIEF DESCRIPTION OF THE DRAWINGS

Other objectives, advantages, and applications of the present invention will, be made clear by the following detailed description of preferred emboditnents of the invention. The description makes reference to the accompanying drawings in which:

FIG. 1 is a perspective view of a football shoe incorporating cleats (“cleats”) being spatted with adhesive tape from a roll incorporating an embodiment of the present invention;

FIG. 2 is a perspective view of a shoe without cleats being similarly spatted by an inventive form of adhesive tape in accordance with the present invention;

FIG. 3 is a perspective view of spatting applied, to a shoe and the adjacent ankle employing tape formed in accordance with the present invention;

FIG. 4 is a perspective view of spatting tape formed in accordance with the present invention; and

FIG. 5 is a bottom view of a football cleat with spatting formed using tape in acordance with the present invention.

### DETAILED DESCRIPTION OF THE PREFERRED EMBODIMENTS

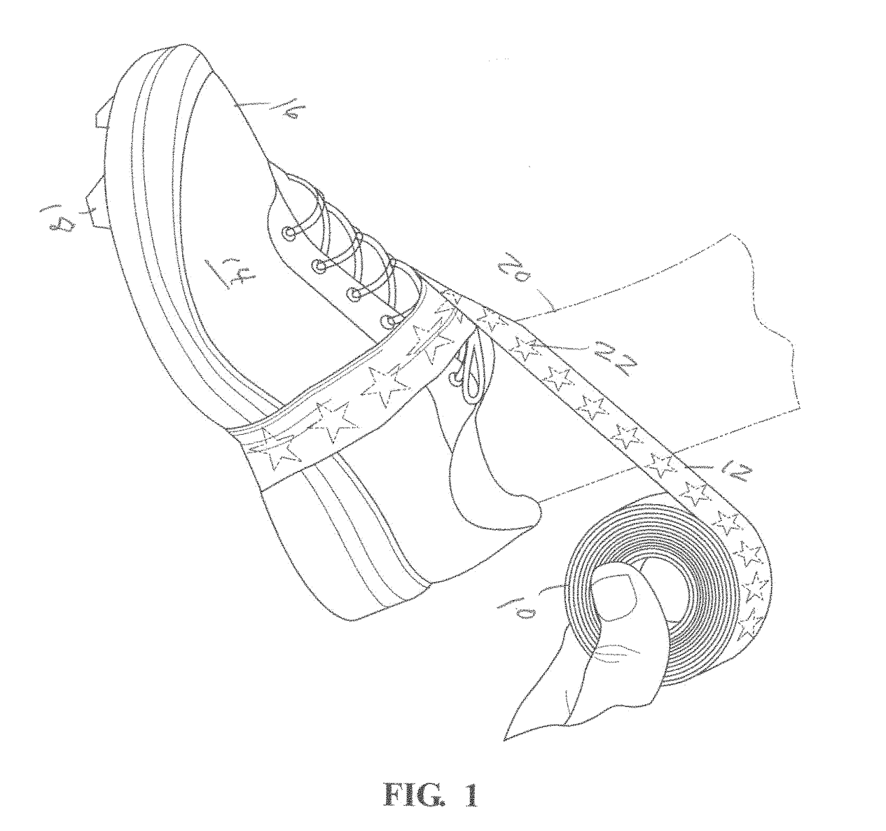

Referring to the drawings, in FIG. 1 a roll 10 of tape 12, formed in accordance with the present invention, is being used to spat a cleat 14. The cleat 14, or football shoe, comprises a conventional tipper 16 having projecting cleats 18 on its bottom surface.

The tape 12 is illustrated as being imprinted on its outer surface with a series of stars. The underside, or the opposed surface, is coated with a pressure-sensitive adhesive to secure the tape to the shoe 14 and portions of the ankle 20 of the wearer. The tape 12 may be imprinted on its upper side with any of a variety of designs, but preferably the logo of a sponsor or of a shoe manufacturer who contracts with a professional football player who wears the shoes. The imprinted legend may be the entity's logo, trademark, motto, or simply the entity's name. The imprinting 22, shown to be a star in FIG. 1, is preferably imprinted on the tape base material which may be any flexible material such as woven fabric, flexible plastic sheeting, or the like. The marking, such as the star 22, and the underlying material may be imprinted in contrasting colors, preferably associated with the sponsor, licensor, or the like.

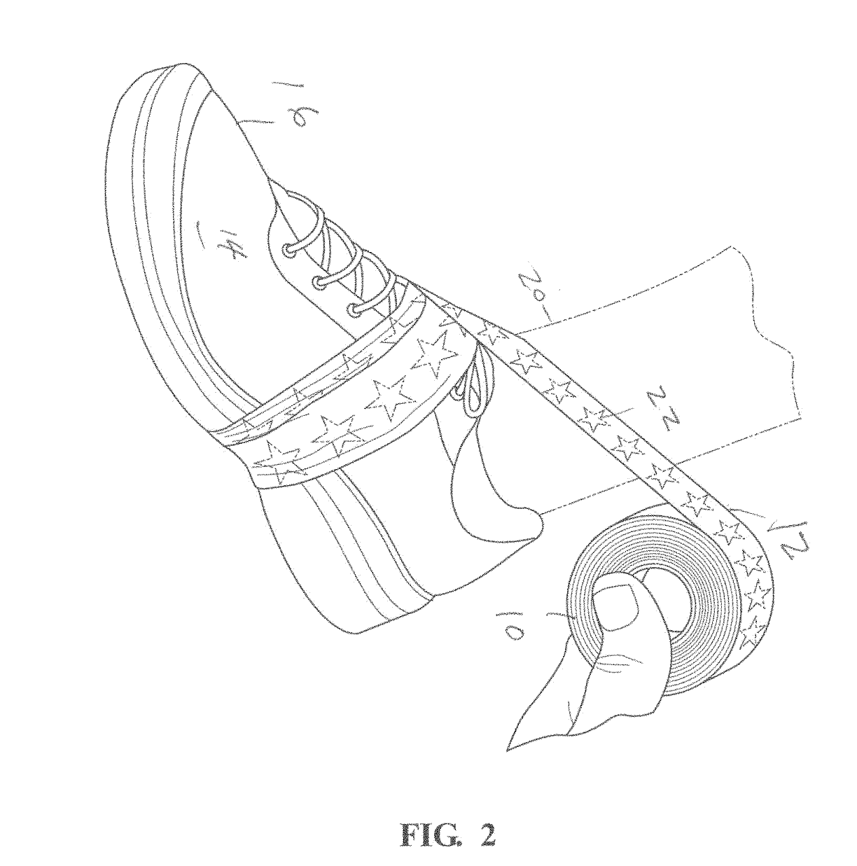

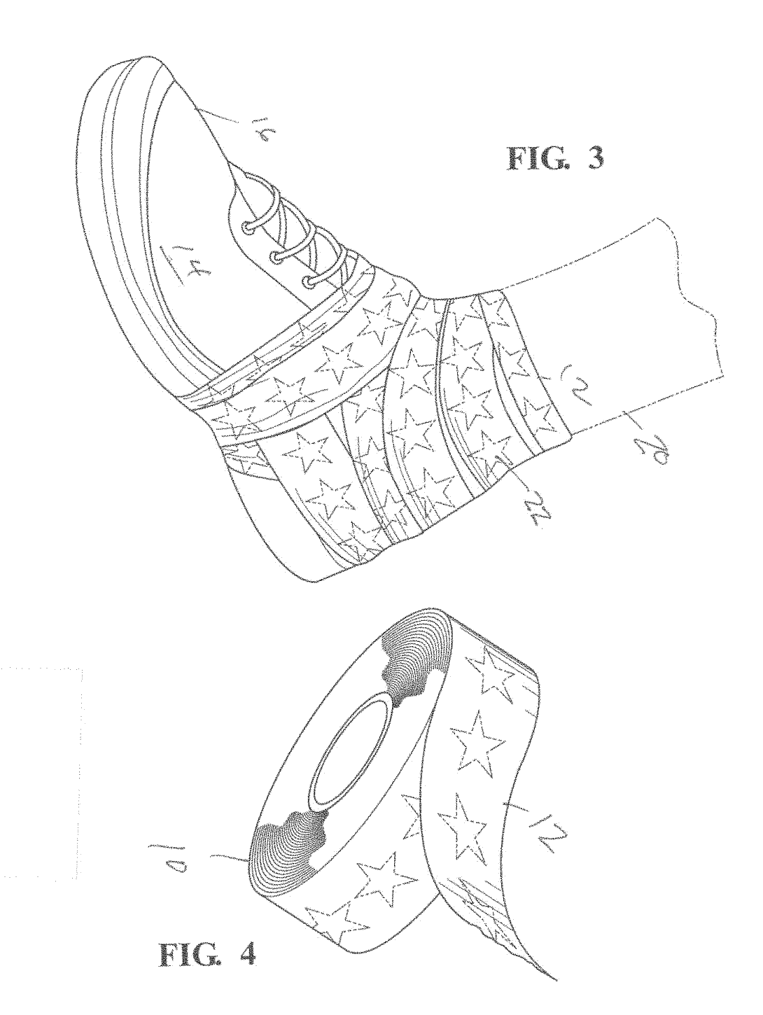

Alternatively, the designs, such as the star 22, might be imprinted on transparent tape, allowing portions of the underlying shoe to be rendered visible. As seen in FIG. 1, the spatting, as is conventional, surrounds the midsection of the shoe and extends across the underside of the shoe. As illustrated in FIG. 3, it further surrounds the ankle of the wearer to provide reinforcing against stresses imposed on the shoe during a sporting activity, in particular preventing sprained ankles. FIG. 2 illustrates how the tape is brought up from the section surrounding the midsection of the shoe and around the ankle, and FIG. 3 illustrates the completed spatting.

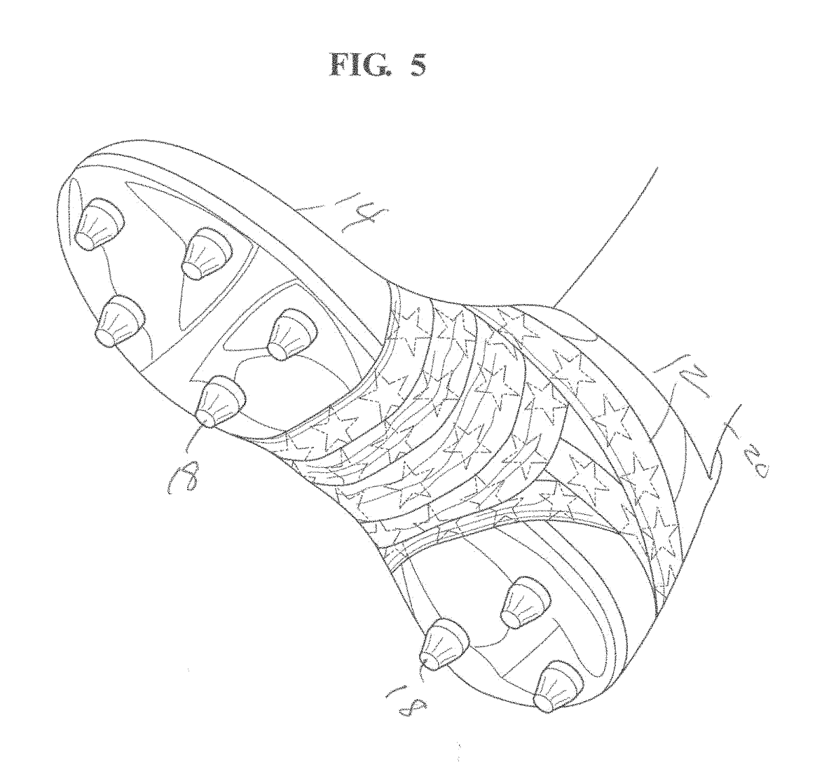

FIG. 5 illustrates the underside of a shoe containing cleats 18 and illustrates the mariner in which the taping extends between the cleats, leaving the cleats to operate in a conventional manner.

Use of the adhesive tape of the present invention to spat a cleat or other athletic shoe thus accommodates the need of a player to reinforce the shoe and foot against the stresses imposed in athletic training and participation in sport events, while providing prominent display of a sponsor's name, logo, motto, or the like.

Having thus disclosed my invention, I claim:

1. A tape for use in spatting cleats or like athletic shoes for a player having a pressure-sensitive coating on one face, the tape being imprinted with a recurring design which is promotional in nature on the opposed surface, so that the tape may be applied to an athletic shoe by wrapping around the shoe and the player's ankle so as to display the design.

2. The tape of claim 1, wherein the tape is transparent.

3. The tape of claim 1, wherein, the tape has a base, imprinted on one side and with pressure-sensitive coating on the opposite side with the base being black and the recurring design being imprinted on one face of the tape in a contrasting color.

4. The tape of claim 1, wherein the recurring design constitutes a logo of the manufacturer of the shoe.

5. The tape of claim 1, wherein the recurring design constitutes a logo of the team on which a player wearing the spatted shoes may play.

6. The tape of claim 1, wherein, the tape is formed of a flexible material chosen from the group comprising woven fabric and flexible plastic sheeting.

7. The tape of claim 1, wherein the design is chosen from the group comprising the shoe's manufacturer and the team for which the player serves.

8. A tape for use in spatting cleats or like athletic shoes for a player, having a flexible backing chosen from the group of materials comprising woven fabric and flexible plastic sheeting, the tape being imprinted with a recurring design chosen from a group comprising the logo of the shoe manufacturer, the trademark of the shoe manufacturer, the motto of the shoe manufacturer, the shoe manufacturers name, the player's team's logo, the player's team's trademark, the player's team's motto, or the player's team's name, so that the tape may be applied to an. athletic shoe by wrapping around the shoe and the player's ankle so as to reinforce the support to the player's foot and ankle and display the design.
